(19) United States
(12) Patent Application Publication
(10) Pub. No.: US 2026/0275805 A1
(43) Pub. Date: Sep. 17, 2026

(54) WINDOW SYSTEM WITH INTEGRATED BLINDS

(71) Applicant: Hawkes Design and Consulting, LLC, Charleston, SC (US)

(72) Inventor: Henry M. Hay, III, Charleston, SC (US)

(73) Assignee: Hawkes Design and Consulting, LLC, Charleston, SC (US)

(21) Appl. No.: 19/077,729

(22) Filed: Mar. 12, 2025

(51) Int. Cl. E06B 9/24

(52) U.S. Cl. CPC E06B 9/24

(57) ABSTRACT

Various window jamb and window jamb assemblies are provided. An example window jamb assembly includes a clipping mechanism attachable to a window jamb. The clipping mechanism includes a first receiving channel and a second receiving channel. The example window jamb assembly also includes a blind bracket removably coupled to the clipping mechanism. The blind bracket includes a first protrusion extending from an attachment side of the blind bracket and a second protrusion extending laterally from the attachment side of the blind bracket. The first protrusion engages the first receiving channel and the second protrusion engages the second receiving channel. The first protrusion and the second protrusion provide a holding force to maintain the coupling of the blind bracket to the clipping mechanism.

### TECHNOLOGICAL FIELD

This disclosure relates generally to a window and door framing system and method, and in particular to a window frame design that includes an integrated blind.

### BACKGROUND

Blinds are often positioned adjacent to a window in order to block unwanted light from entering the inside area. Traditionally, blinds are either outside mount or inside mount, such that the blinds are mounted either outside the outer edges of a window or between the frame of the window. Outside mounted blind brackets are traditionally installed above the window directly into a wall (e.g., into a stud in the wall). However, this causes damage to the wall surrounding the window, as well as takes unnecessary space around the window. Thus, there is a long sought need to provide windows that provide for unitary blind installation.

### BRIEF SUMMARY

The following paragraphs present a summary of various embodiments of the present disclosure and are merely examples of potential embodiments. As such, the summary is not meant to limit the subject matter or variations of various embodiments discussed herein.

In some aspects, the techniques described herein relate to a window jamb assembly, including: a clipping mechanism attachable to a window jamb, wherein the clipping mechanism includes a first receiving channel and a second receiving channel; and a blind bracket removably coupled to the clipping mechanism, wherein the blind bracket includes a first protrusion extending from an attachment side of the blind bracket and a second protrusion extending laterally from the attachment side of the blind bracket, wherein the first protrusion engages the first receiving channel and the second protrusion engages the second receiving channel, and wherein the first protrusion and the second protrusion provide a holding force to maintain the coupling of the blind bracket to the clipping mechanism.

In some aspects, the techniques described herein relate to a window jamb assembly, wherein the clipping mechanism is attachable to the window jamb via at least one fastener, wherein the window jamb includes a screw boss to receive the at least one fastener.

In some aspects, the techniques described herein relate to a window jamb assembly, wherein a portion of the first receiving channel is parallel to the first protrusion, wherein the first protrusion engages the portion of the first receiving channel is parallel upon engagement of the blind bracket and the clipping mechanism.

In some aspects, the techniques described herein relate to a window jamb assembly, wherein the first protrusion defines an angle less than 90 degrees relative to the attachment side of the blind bracket.

In some aspects, the techniques described herein relate to a window jamb assembly, wherein the first protrusion restricts a rotational force of the blind bracket.

In some aspects, the techniques described herein relate to a window jamb assembly, wherein the first receiving channel is defined between a first channel protrusion and a bracket side of the clipping mechanism.

In some aspects, the techniques described herein relate to a window jamb assembly, wherein the first protrusion engages the first receiving channel via engagement of a tooth structure with a channel protrusion within the first receiving channel.

In some aspects, the techniques described herein relate to a window jamb assembly, wherein the blind bracket includes a first tab on an extending side of the blind bracket and a second tab on the attachment side of the blind bracket, wherein a blind is attachable to the blind bracket via an engagement with the first tab and the second tab.

In some aspects, the techniques described herein relate to a window jamb assembly, wherein the attachment side of the blind bracket is perpendicular to an extending side of the blind bracket.

In some aspects, the techniques described herein relate to a window jamb assembly, wherein the first protrusion is shorter than the second protrusion.

In some aspects, the techniques described herein relate to a method of installing a window jamb assembly, the method including: attaching a clipping mechanism attachable to a window jamb, wherein the clipping mechanism includes a first receiving channel and a second receiving channel; and coupling a blind bracket to the clipping mechanism, wherein the blind bracket includes a first protrusion extending from an attachment side of the blind bracket and a second protrusion extending laterally from the attachment side of the blind bracket, wherein coupling the blind bracket to the clipping mechanism includes engaging the first protrusion with the first receiving channel and engaging the second protrusion with the second receiving channel, and wherein the first protrusion and the second protrusion provide a holding force to maintain the coupling of the blind bracket to the clipping mechanism.

In some aspects, the techniques described herein relate to a method, wherein the clipping mechanism is attached to the window jamb via at least one fastener, wherein the window jamb includes a screw boss to receive the at least one fastener.

In some aspects, the techniques described herein relate to a method, wherein a portion of the first receiving channel is parallel to the first protrusion, wherein the first protrusion engages the portion of the first receiving channel is parallel upon engagement of the blind bracket and the clipping mechanism.

In some aspects, the techniques described herein relate to a method, wherein the first protrusion defines an angle less than 90 degrees relative to the attachment side of the blind bracket.

In some aspects, the techniques described herein relate to a method, wherein the first protrusion restricts a rotational force of the blind bracket.

In some aspects, the techniques described herein relate to a method, wherein the first receiving channel is defined between a first channel protrusion and a bracket side of the clipping mechanism.

In some aspects, the techniques described herein relate to a method, wherein the first protrusion engages the first receiving channel via engagement of a tooth structure with a channel protrusion within the first receiving channel.

In some aspects, the techniques described herein relate to a method, wherein the blind bracket includes a first tab on an extending side of the blind bracket and a second tab on the attachment side of the blind bracket, wherein a blind is attachable to the blind bracket via an engagement with the first tab and the second tab.

In some aspects, the techniques described herein relate to a method, wherein the attachment side of the blind bracket is perpendicular to an extending side of the blind bracket.

In some aspects, the techniques described herein relate to a method, wherein the first protrusion is engaged with the first receiving channel before the second protrusion engages with the second receiving channel during the coupling of the blind bracket and the clipping mechanism.

In some aspects, the techniques described herein relate to a window jamb assembly, including: a clipping mechanism attachable to a window jamb, wherein the clipping mechanism includes a first receiving channel and a second receiving channel, wherein the clipping mechanism is attachable to a window jamb via at least one friction fitting between the clipping mechanism and the window jamb; and a blind bracket removably coupled to the clipping mechanism, wherein the blind bracket includes a first protrusion extending from an attachment side of the blind bracket and a second protrusion extending laterally from the attachment side of the blind bracket, wherein the first protrusion engages the first receiving channel and the second protrusion engages the second receiving channel, and wherein the first protrusion and the second protrusion provide a holding force to maintain the coupling of the blind bracket to the clipping mechanism.

In some aspects, the techniques described herein relate to a window jamb assembly, wherein the clipping mechanism is attachable to the window jamb via at least one fastener, wherein the window jamb includes a screw boss to receive the at least one fastener.

In some aspects, the techniques described herein relate to a window jamb assembly, wherein a portion of the first receiving channel is parallel to the first protrusion, wherein the first protrusion engages the portion of the first receiving channel is parallel upon engagement of the blind bracket and the clipping mechanism.

In some aspects, the techniques described herein relate to a window jamb assembly, wherein the first protrusion defines an angle less than 90 degrees relative to the attachment side of the blind bracket.

In some aspects, the techniques described herein relate to a window jamb assembly, wherein the first protrusion restricts a rotational force of the blind bracket.

In some aspects, the techniques described herein relate to a window jamb assembly, wherein the first receiving channel is defined between a first channel protrusion and a bracket side of the clipping mechanism.

In some aspects, the techniques described herein relate to a window jamb assembly, wherein the first protrusion engages the first receiving channel via engagement of a tooth structure with a channel protrusion within the first receiving channel.

In some aspects, the techniques described herein relate to a window jamb assembly, wherein the blind bracket includes a first tab on an extending side of the blind bracket and a second tab on the attachment side of the blind bracket, wherein a blind is attachable to the blind bracket via an engagement with the first tab and the second tab.

In some aspects, the techniques described herein relate to a window jamb assembly, wherein the attachment side of the blind bracket is perpendicular to an extending side of the blind bracket.

In some aspects, the techniques described herein relate to a window jamb assembly, wherein the first protrusion is shorter than the second protrusion.

In some aspects, the techniques described herein relate to a window jamb assembly, wherein the blind bracket defines a fastener aperture on an extending side of the blind bracket to fasten the blind bracket to a ceiling or a wall.

In some aspects, the techniques described herein relate to a method of installing a window jamb assembly, the method including: attaching a clipping mechanism attachable to a window jamb, wherein the clipping mechanism includes a first receiving channel and a second receiving channel, wherein the clipping mechanism is attached to a window jamb via at least one friction fitting between the clipping mechanism and the window jamb; and coupling a blind bracket to the clipping mechanism, wherein the blind bracket includes a first protrusion extending from an attachment side of the blind bracket and a second protrusion extending laterally from the attachment side of the blind bracket, wherein coupling the blind bracket to the clipping mechanism includes engaging the first protrusion with the first receiving channel and engaging the second protrusion with the second receiving channel, and wherein the first protrusion and the second protrusion provide a holding force to maintain the coupling of the blind bracket to the clipping mechanism.

In some aspects, the techniques described herein relate to a method, wherein the clipping mechanism is attached to the window jamb via at least one fastener, wherein the window jamb includes a screw boss to receive the at least one fastener.

In some aspects, the techniques described herein relate to a method, wherein a portion of the first receiving channel is parallel to the first protrusion, wherein the first protrusion engages the portion of the first receiving channel is parallel upon engagement of the blind bracket and the clipping mechanism.

In some aspects, the techniques described herein relate to a method, wherein the first protrusion defines an angle less than 90 degrees relative to the attachment side of the blind bracket.

In some aspects, the techniques described herein relate to a method, wherein the first protrusion restricts a rotational force of the blind bracket.

In some aspects, the techniques described herein relate to a method, wherein the first receiving channel is defined between a first channel protrusion and a bracket side of the clipping mechanism.

In some aspects, the techniques described herein relate to a method, wherein the first protrusion engages the first receiving channel via engagement of a tooth structure with a channel protrusion within the first receiving channel.

In some aspects, the techniques described herein relate to a method, wherein the blind bracket includes a first tab on an extending side of the blind bracket and a second tab on the attachment side of the blind bracket, wherein a blind is attachable to the blind bracket via an engagement with the first tab and the second tab.

In some aspects, the techniques described herein relate to a method, wherein the attachment side of the blind bracket is perpendicular to an extending side of the blind bracket.

In some aspects, the techniques described herein relate to a method, wherein the first protrusion is engaged with the first receiving channel before the second protrusion engages with the second receiving channel during the coupling of the blind bracket and the clipping mechanism.

In some aspects, the techniques described herein relate to a window jamb assembly, further including securing the blind bracket to a wall via an attachment fastener, wherein the blind bracket defines a fastener aperture on an extending side of the blind bracket to fasten the blind bracket to the wall via the attachment fastener.

These and other advantages will be apparent to those skilled in the art of window design and installation particularly for buildings in areas where security or severe weather is a concern.

### BRIEF DESCRIPTION OF THE DRAWINGS

Many aspects of the present disclosure will be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views. It should be recognized that these implementations and embodiments are merely illustrative of the principles of the present disclosure. Therefore, in the drawings

FIGS. 1A and 1B illustrate various cross-sections of example embodiments of an extruded lineal for a window, in accordance with various embodiments of the present disclosure;

FIGS. 2A and 2B illustrates a window jamb assembly with the window jamb of FIG. 1A, in accordance with various embodiments of the present disclosure;

FIG. 3 illustrates an example clipping mechanism used in a window jamb assembly, in accordance with various embodiments of the present disclosure;

FIG. 4 illustrate an example blind bracket used in a window jamb assembly, in accordance with various embodiments of the present disclosure;

FIG. 5 illustrates the clipping mechanism of FIG. 3 attached to the window jamb of FIG. 1A, in accordance with various embodiments of the present disclosure;

FIG. 6A illustrates the coupling of the blind bracket to the clipping mechanism, in accordance with various embodiments of the present disclosure;

FIG. 6B illustrates the blind installed within the blind bracket, in accordance with various embodiments of the present disclosure;

FIG. 7 illustrates an example window jamb assembly without a window jamb, in accordance with various embodiments of the present disclosure;

FIGS. 8A and 8B illustrates a window jamb assembly with the window jamb of FIG. 1B, in accordance with various embodiments of the present disclosure;

FIG. 9 illustrates an example clipping mechanism attached to the window jamb of FIG. 1B, in accordance with various embodiments of the present disclosure;

FIG. 10A illustrates the coupling of the blind bracket to the clipping mechanism, in accordance with various embodiments of the present disclosure;

FIG. 10B illustrates the coupling of the blind to the blind bracket, in accordance with various embodiments of the present disclosure; and

FIG. 11 illustrates another installation method for the window jamb assembly, in accordance with various embodiments of the present disclosure.

### DETAILED DESCRIPTION

The presently disclosed subject matter now will be described more fully hereinafter with reference to the accompanying drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements.

Indeed, many modifications and other embodiments of the presently disclosed subject matter set forth herein will come to mind to one skilled in the art to which the presently disclosed subject matter pertains having the benefit of the teachings presented in the foregoing descriptions and the associated drawings. Therefore, it is to be understood that the presently disclosed subject matter is not to be limited to the specific embodiments disclosed and that modifications and other embodiments are intended to be included within the scope of the appended claims.

Throughout this specification and the claims, the terms “comprise,” “comprises”, and “comprising” are used in a non-exclusive sense, except where the context requires otherwise. Likewise, the term “includes” and its grammatical variants are intended to be non-limiting, such that recitation of items in a list is not to the exclusion of other like items that can be substituted or added to the listed items.

The term “astragal” refers to hardware that is used on a pair of doors to seal the gap between the doors when they are closed. The astragal is fastened to the doors themselves on the sides of the doors that meet, rather than to a separate door frame.

The term “building” will be used here for convenience to mean any structure with openings in its walls. The structure includes by way of example, and not of limitation, homes, apartment buildings, and commercial buildings. The word “walls” refers to barriers such as walls, ceilings, and floors, that are positioned between the inside of the building and its outside.

The term “customizable” is used herein to describe the ability to choose from a selection of options among protective mechanisms that protect the interior of a building from physical damage as a result of severe weather or a security threat outside the building. The features selected from among the options are added to an extruded, pultruded, or co-extruded frame of a that was manufactured with specific elements. These protective mechanisms improve the ability of the window or door to withstand increased stress from a security threat, high winds, heavy rain, hurricanes, and flying debris or hail.

The term “door” will be used to indicate an entry and egress point in a building, and shall include framing along with the ability to cover the door with the disclosure herein.

The term “extruded” is used herein for convenience but jambs, sills and headers may be formed in any way customary in the industry, for example, pultruded, and co-extruded with other materials.

The term “frame” as used herein, and used in connection with a window or door, such as a “window frame” an “opening frame” or a “door frame,” refers to the structure that is attached to a building where a hole has been made in the building for receiving a window or door (or receiving a vent or an appliance such as a wall-mounted air conditioner). The frame is typically a four-sided structure that is sealed to the opening made for it and that holds the window, door, vent, or appliance. In various embodiments, the term “frame” and the term “jamb” may be used interchangeably unless otherwise indicated.

The term “jamb” may refer to any of the individual sections of a frame. For example, the frame may include a first jamb, a second jamb, a header, and a sill. Each of the first jamb, a second jamb, a header, and a sill may be referred to as a “jamb” or “window jamb.”

The term “window” will be used to refer to an opening in a wall, as defined herein, such as a window in a wall, a window in a door, a skylight in a ceiling, or a sliding glass door in a wall, where the window has a covering that admits light, unlike the opaque material of the wall, door frame, and roof.

The term “screw boss” is a physical structure that grips the threads of a screw being driven into it so that, once the screw has been inserted into or through the screw boss, the screw boss resists the removal of the screw more when the screw is pulled than when the screw is unscrewed. This installation further provides support for attachments such as high wind panels, blinds, and other attachments, allowing for additional weight support in the frame. While the various screw bosses discussed herein are referred to in the singular, a screw boss shown in a lineal profile of a window jamb may represent multiple screw bosses defined along the window jamb. For example, a screw boss may be provided at each location along a window jamb in which an aperture is defined.

An “insertable screw boss” is a screw boss that has been separately extruded so that it can be inserted into a channel and is otherwise functionally the same as a screw boss extruded as an integral part of that channel, but allowing for further customization depending upon the time of fastener. This installation further provides support for attachments such as high wind panels, blinds, and other attachments, allowing for additional weight support in the frame.

The term “window treatment” means a cover or modification of a window, with an aim of enhancing the aesthetics of the window. For purposes of this definition a window may also appear on a door. Further, a window treatment encompasses hard treatments such as wood, vinyl, aluminum, and window blinds, shades, and drapery fixtures. Additionally, the term “blind” may include various other types of window treatments discussed herein.

Any of the components discussed herein may be made out of any number of different materials (e.g., aluminum, plastic, composite materials, etc.). In various embodiments, one or more of the components discussed herein may be manufactured via an extruding process.

### I. Example Use Case

Blinds are often positioned on the interior of a window in order to block unwanted light from the inside area. Traditionally, blinds are either outside mount or inside mount, such that the blinds are mounted either outside the outer edges of a window or between the frame of the window. Outside mounted blind brackets are traditionally required to be installed above the window directly into a wall (e.g., into a stud of the wall). However, this causes damage to the wall surrounding the window, as well as takes unnecessary space around the window. Thus, there is a long sought need to provide window that provides for unitary blind installation.

In various embodiments of the present disclosure, window jamb assemblies are provided that allow a blind to be attached to the window jamb with little to no additional tools. To do this, the window jamb assembly includes a clipping mechanism 205 and a blind bracket 210. The clipping mechanism 205 is attachable to the window jamb at a first end of the window jamb. The clipping mechanism 205 may be attached via a fastener and/or friction fit with the window jamb. The clipping mechanism 205 may be designed specifically for the window jamb (e.g., to include protrusions to engage with channels within the window jamb) or the clipping mechanism 205 may be used across any number of different window jamb designs.

The clipping mechanism 205 includes a first receiving channel and a second receiving channel. The first receiving channel is angled to receive a first protrusion from the blind bracket 210 and the second receiving channel is extends laterally to receive a second protrusion from the blind bracket. The first protrusion of the blind bracket is angled and the second of the blind bracket extends laterally. During installation, the first protrusion is inserted into the first receiving channel and the blind bracket is rotated to allow the second protrusion to be inserted into the second receiving channel. The blind bracket 210 is then coupled to the clipping mechanism 205 without any additional tools. A blind may then be coupled (via a snap-fit) into the blind bracket 210.

### II. Systems and Methods

In some aspects, the techniques described herein relate to a window jamb assembly, including: a clipping mechanism attachable to a window jamb, wherein the clipping mechanism includes a first receiving channel and a second receiving channel; and a blind bracket removably coupled to the clipping mechanism, wherein the blind bracket includes a first protrusion extending from an attachment side of the blind bracket and a second protrusion extending laterally from the attachment side of the blind bracket, wherein the first protrusion engages the first receiving channel and the second protrusion engages the second receiving channel, and wherein the first protrusion and the second protrusion provide a holding force to maintain the coupling of the blind bracket to the clipping mechanism.

In some aspects, the techniques described herein relate to a method of installing a window jamb assembly, the method including: attaching a clipping mechanism attachable to a window jamb, wherein the clipping mechanism includes a first receiving channel and a second receiving channel; and coupling a blind bracket to the clipping mechanism, wherein the blind bracket includes a first protrusion extending from an attachment side of the blind bracket and a second protrusion extending laterally from the attachment side of the blind bracket, wherein coupling the blind bracket to the clipping mechanism includes engaging the first protrusion with the first receiving channel and engaging the second protrusion with the second receiving channel, and wherein the first protrusion and the second protrusion provide a holding force to maintain the coupling of the blind bracket to the clipping mechanism.

In some aspects, the techniques described herein relate to a window jamb assembly, including: a clipping mechanism attachable to a window jamb, wherein the clipping mechanism includes a first receiving channel and a second receiving channel, wherein the clipping mechanism is attachable to a window jamb via at least one friction fitting between the clipping mechanism and the window jamb; and a blind bracket removably coupled to the clipping mechanism, wherein the blind bracket includes a first protrusion extending from an attachment side of the blind bracket and a second protrusion extending laterally from the attachment side of the blind bracket, wherein the first protrusion engages the first receiving channel and the second protrusion engages the second receiving channel, and wherein the first protrusion and the second protrusion provide a holding force to maintain the coupling of the blind bracket to the clipping mechanism.

In some aspects, the techniques described herein relate to a method of installing a window jamb assembly, the method including: attaching a clipping mechanism attachable to a window jamb, wherein the clipping mechanism includes a first receiving channel and a second receiving channel, wherein the clipping mechanism is attached to a window jamb via at least one friction fitting between the clipping mechanism and the window jamb; and coupling a blind bracket to the clipping mechanism, wherein the blind bracket includes a first protrusion extending from an attachment side of the blind bracket and a second protrusion extending laterally from the attachment side of the blind bracket, wherein coupling the blind bracket to the clipping mechanism includes engaging the first protrusion with the first receiving channel and engaging the second protrusion with the second receiving channel, and wherein the first protrusion and the second protrusion provide a holding force to maintain the coupling of the blind bracket to the clipping mechanism.

In some aspects, the techniques described herein relate to a method for manufacturing and assembling a window jamb assembly.

### III. With Reference to the Figures

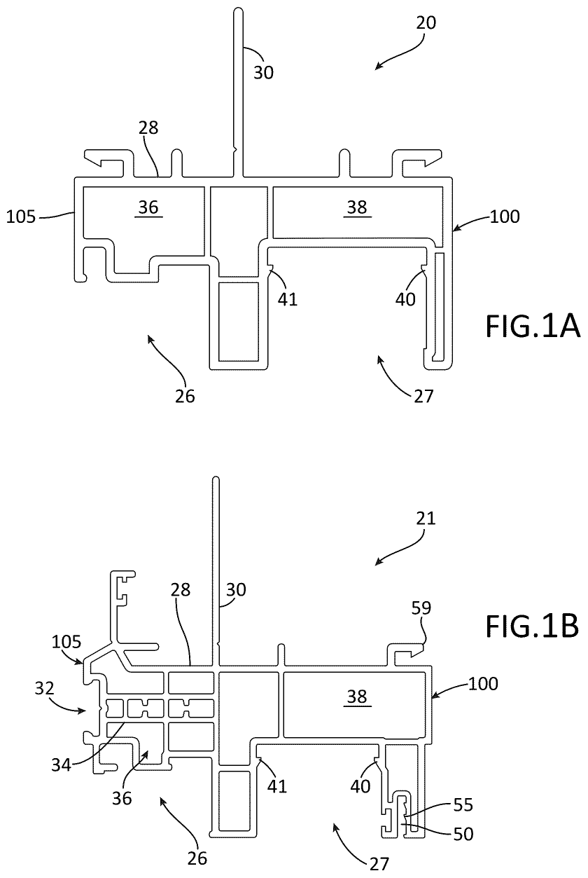

Referring now to FIGS. 1A and 1B, an end view of example lineal profiles (e.g., lineal profile of the window jamb 20 of FIG. 1A and lineal profile 21 of the window jamb 21 of FIG. 1B) used in a window frame are shown. The first window jamb 20 of FIG. 1A and the second window jamb 21 of FIG. 1B are merely example window jambs used in various embodiments of the present disclosure. As such, various lineal profile designs may include the features discussed herein. As discussed above, the window jamb may include any section of the frame (e.g., jambs, sill, header, etc.). The window jambs 20, 21 are merely example window jambs and the window jamb assembly discussed herein may use any kind of window jamb that allows the clipping mechanism to be coupled to the window jamb. Additionally, the window jambs 20, 21 may be altered or use additional components to be used in various embodiments.

In various embodiments, the window jamb may be used in window. The window may include a first jamb, a second jamb, a header, and a sill (collectively “window jambs”). Any of the first jamb, the second jamb, the header, and/or the sill may be a window jamb of various embodiments. Each of the window jambs may include a glazing recess to receive a glazing (e.g. glass for a window). The window may include a storm track on the exterior of the window to receive a covering.

The window jambs of various embodiments, such as the window jambs shown in FIGS. 1A and 1B may be long, rigid, co-co-extruded article of manufacture that are to be cut into sections. The sections have a specified length and can be assembled (usually the frame has four sections including two jambs, a sill, and a header) into a rectangle that defines a (rectangular) window frame. The lineal profiles shown in FIGS. 1A and 1B contain representative internal features common to many window frames. The features of window jamb (e.g., the first window jamb 20 of FIG. 1A and/or the second window jamb 21 of FIG. 1B) have specific functions and some are decorative, namely those on the first end 100 and second end 105 of FIGS. 1A and 1B which will become the interior and exterior ends, respectively, of a window frame. The second end 105 (shown in FIGS. 1A and 1B) is the exterior-facing configuration of the frame, and the first end 100 (shown in FIGS. 1A and 1B) is the interior-facing side of the frame.

Referring now to lineal profile of the first window jamb 20 of FIG. 1A, the first window jamb 20 is shown. Unless otherwise stated, the second window jamb 21 of FIG. 1B includes each of the features of the first window jamb 20. In various embodiments, the first window jamb 20 includes a first end 100 and a second end 105. The first end 100 of the first window jamb 20 is structured to be positioned as the inside of the window and the second end 105 of the first window jamb 20 is structured to be positioned as the exterior of the window. For example, for an exterior facing window, the first end 100 of the first window jamb 20 is positioned adjacent to the inside of the given structure and the second end 105 of the first window jamb 20 positioned adjacent the outside of the given structure. As such, the first end 100 of the first window jamb 20 may be positioned on an interior of a structure, such that a blind and/or curtain may be positioned adjacent to selectively cover the window. In various embodiments, the first window jamb 20 may be structured such that the blinds may be attached at the first end 100. The second window jamb 21 of FIG. 1B also includes a first end 100 and a second end 105 that are also structured to be the interior end (the first end 100) and the exterior end (the second end 105).

As shown in FIGS. 1A and 1B, the window jambs are structured to receive one or more windows (e.g., one or more glazed windows) which will fit into recess 26 and/or recess 27. As discussed herein, the recess 27 may additionally or alternatively be used to receive an insertable attachment component for a blind to be installed. The wall attachment side 28 of FIGS. 1A and 1B are the part of given widow jamb that is to be attached to the wall of the building. A nail fin 30 extending from the wall attachment side 28 permits the frame of a window to be attached to the framing of the building at the opening for the window.

In various embodiments, the recess 27 may be structured to receive an insertable attachment component. The recess may have a first protrusion 40 and a second protrusion 41. The first protrusion 40 and/or the second protrusion 41 may engage the insertable attachment component to couple the insertable attachment component and the window jamb. As such, the insertable attachment component may be structured with a tooth structure to receive the first protrusion 40 and/or the second protrusion 41.

In various embodiments, the window jambs may include one or more receptor channels (e.g., receptor channel 32, receptor channel 36, receptor channel 38, and/or the like). The lineal profile of the second window jamb 21 of FIG. 1B includes a receptor channel 32 and a co-co-extruded first screw boss 34 in a receptor channel 36. These features, receptor channel 32 and first screw boss 34, facilitate attachment of a panel or other protective exterior covering for protection of glazing held by the frame (e.g., within recess 26 and/or recesses 27), and is co-co-extruded as part of linear profile of the given window jamb. The second end 105 may be flat or have another configuration and may be ornamental as it is the part of window jamb that faces to the exterior.

A screw or other fastener may be driven left to right (as oriented in the FIG. 1B) into the second end 105 of FIG. 1B into receptor channel 32, which serves to guide the screw or other fastener into first screw boss 34, which provides additional holding power against withdrawal of screws used to hold a panel to first window jamb 20. Various embodiments of a window jamb may include any number of screw bosses positioned within receptor channels (e.g., receptor channel 36 and/or receptor channel 38). The first screw boss 34 may be structured to receive a screw to hold on a storm cover. In various embodiments, a window jamb may be structured (e.g., via a screw boss or other attachment means) to allow for a storm cover (e.g., a protective fabric, a wood or otherwise solid panel, and/or the like) to be attached. The storm cover may be attached by screwing one or more screws into the given window jamb. While the term “screw” is used herein, any number of different fasteners may be used herein and the term screw is not meant to be limiting to exclusively screws.

As discussed herein, a screw boss (e.g., the first screw boss 34 shown in FIG. 1B) is a device that may be made separately from window jamb by extrusion, and which a screw boss presents a series of barriers across a long dimension to the advancement of a screw inserted at receptor channel 32 and driven into any one of the window jambs of various embodiments. For example, the tip of a long screw penetrates into first screw boss 34 on insertion into the second window jamb 21. A long screw is more difficult to withdraw from a screw boss, such as first screw boss 34, by pulling than to unscrew it, and thus provides resistance to the removal of the screw by force—and thus resists the wind's effect on a panel or other covering over the window. Plural screws (not shown) along the window frame made using the various window jambs may be used to hold such a panel (not shown) to the exterior of an extruded window frame. The presence of screw bosses in at least two sides of window frame, jambs or sill and header, for example, provide additional security against the force of strong winds pulling on the panel or fabric covering of the frame and subsequently exposing the window glazing to damage.

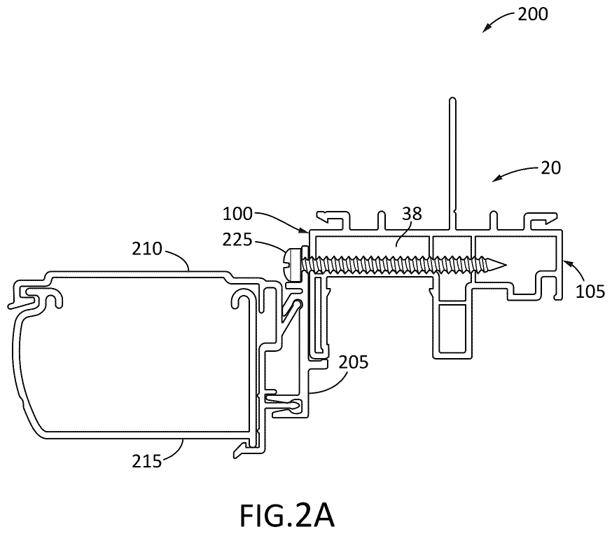

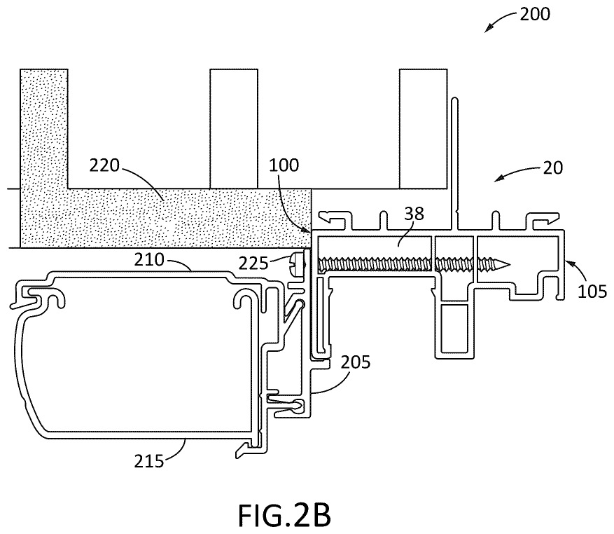

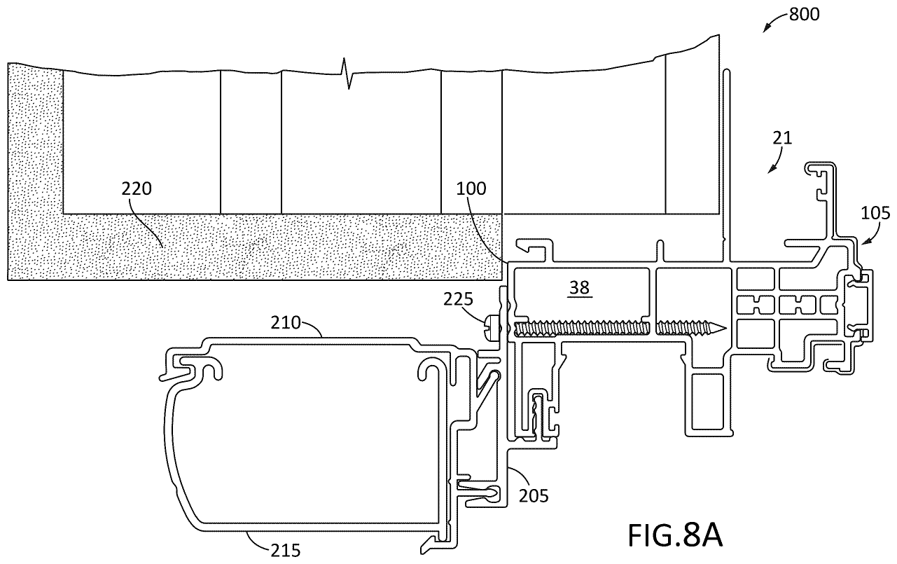

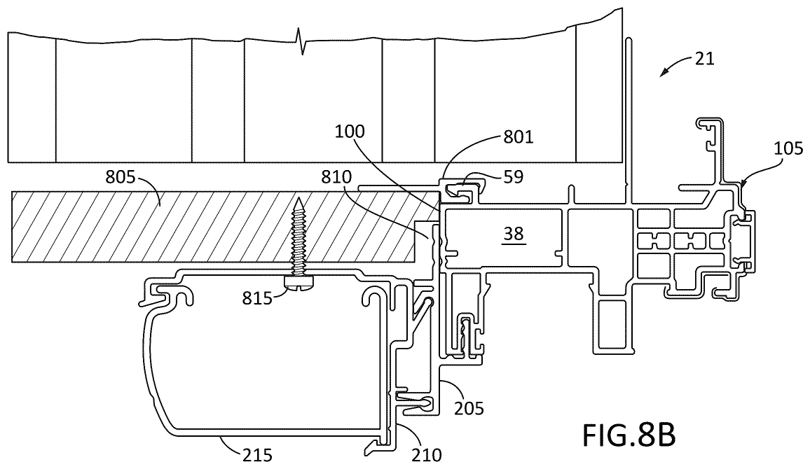

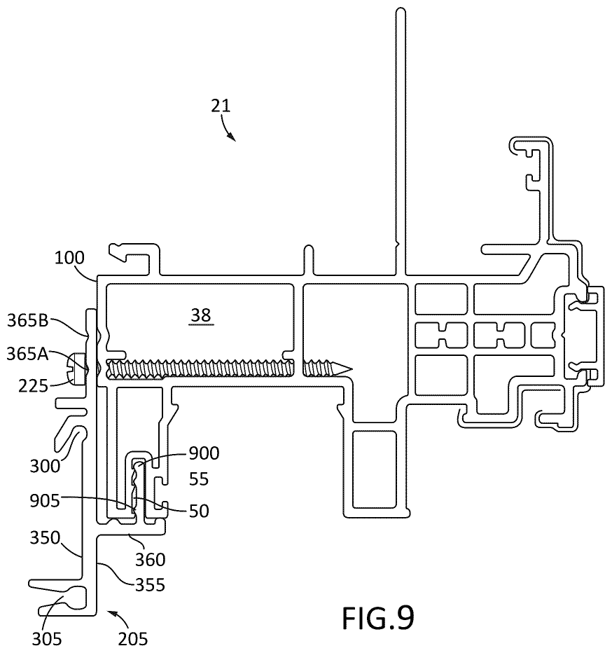

In various embodiments, a clipping mechanism channel 50 may be provided adjacent to the first end 100. The clipping mechanism channel 50 may receive a clipping mechanism protrusion 900 shown in FIG. 9. The clipping mechanism channel 50 may include one or more channel protrusions 55 to engage with the clipping mechanism protrusion 900 (e.g., one or more teeth protrusions 905 of the clipping mechanism protrusion 900). In various embodiments, the clipping mechanism 205 may be designed based on the type of window jamb used. For example, the clipping mechanism shown in FIGS. 2A-7 may be designed specifically for window jamb 20 and the clipping mechanism shown in FIGS. 8A-11 may be designed specifically for window jamb 21. In various embodiments, the clipping mechanism 205 may be generic to the window jamb design, such that a clipping mechanism may be used for one or more different window jambs.

The window jambs may have additional channels to couple the window jamb to other components. For example, the window jamb 21 includes an adapter channel 59 that may allow an adapter (e.g., extender 801 shown in FIG. 8B) to connect to the window jamb 21. The adapter channel 59 may have a hook or gripping structure to engage with an adapter, such as the extender 801 shown in FIG. 8B. A window jamb design may have various adapter channels that may be provided to allow for different installation styles. As such, the adapter channel may not necessarily being used for every mounting configuration. For example, the adapter channel 59 is used to couple the extender 801 in FIG. 8B, but is not used in the drywall return configuration shown in FIG. 8A.

Thus, when multiple windows of a building may have different levels of window protection and yet look the same from the exterior, flexibility in providing that particular level for the windows can be achieved by the use of inserted screw bosses for specific windows. Some windows do not need impact resistant glass, and some windows do not need co-extruded internal and external screw bosses, so the ability to decide whether to add screw bosses as the windows are built enables considerable flexibility and economy in accommodating the individual needs for window protection.

Also, some components of a frame do not need to contain screw bosses. Inserting screw bosses in headers and sills uses shorter segments of screw bosses then when screw bosses are inserted in the jambs. This is a feature of the present disclosure. In addition to flexibility in choosing whether to insert screw bosses or not in any particular window frame, there is also the flexibility in determining if screw bosses are to be used in the header and sill of a frame rather than in the jambs, or in the jambs and not in the header and the sill.

In addition to windows and other framed openings, doors may also provide protection from damage from severe weather.

FIGS. 2A-7 illustrate an example embodiment of a window jamb assembly 200 installed using a window jamb 20 shown in FIG. 1A. Each of FIGS. 2A-7 are end view of example lineal profiles (e.g., lineal profile of each of the window jamb 20, the clipping mechanism 205, the blind bracket 210, and/or the blind 215) used in a window frame are shown. The first window jamb 20 is merely an example window jamb used in various embodiments of the present disclosure. As such, various lineal profile designs may include the features discussed herein. As discussed above, the window jamb may include any section of the frame (e.g., jambs, sill, header, etc.). While the window jamb assembly 200 is shown using window jamb 20 of FIG. 1A, any number of different window jamb designs may be used with the same or similar components. As such, unless otherwise stated, the components of the window jamb assembly 200 (e.g., the clipping mechanism 205, the blind bracket 210, the blind 215, etc.) may be used with other window jamb designs, such as the window jamb 21 of FIG. 1B. Additionally, the components of FIGS. 2A-7 may be interchanged with the components of FIGS. 8A-11 unless otherwise stated.

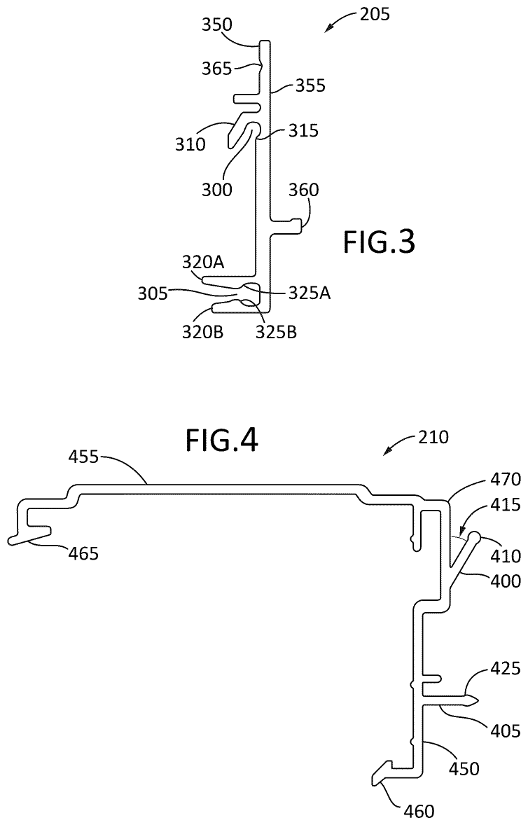

Referring now to FIGS. 2A and 2B, a window jamb assembly 200 is shown installed on a window jamb 20. The window jamb assembly 200 includes a window jamb (e.g., window jamb 20), a clipping mechanism 205, and a blind bracket 210. A blind 215 may be attachable to the blind bracket 210, as shown in FIGS. 2A and 2B. The clipping mechanism 205 is shown individually in FIG. 3 and the blind bracket 210 is shown individually in FIG. 4. FIG. 2B illustrates the window jamb 20 (along with the rest of the window jamb assembly 200) mounted (e.g., within a window aperture) in a drywall return configuration. As such, the wall 220 is shown based on an example installation. In various embodiments, the window jamb assembly 200 may be installed on any type of window mounting (e.g., the clipping mechanism 205 may be attached to a window jamb mounted in any number of different ways).

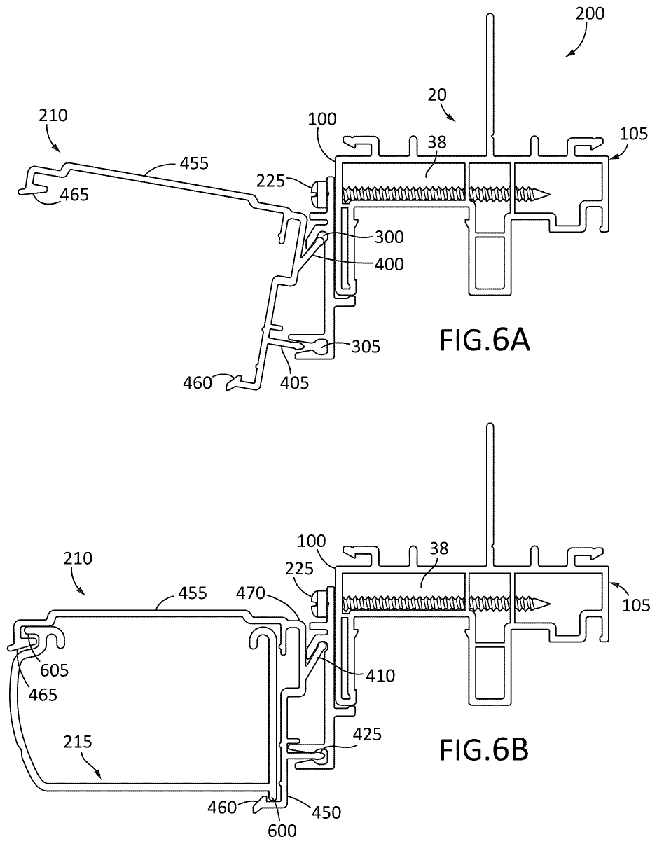

As discussed herein, the clipping mechanism 205 may be attachable to the window jamb via a fastener (e.g., fastener 225). As shown in FIGS. 8A and 8B, the clipping mechanism 205 may have one or more protrusions to friction fit with the window jamb (e.g. in an instance in which the window jamb has a clipping mechanism channel 50, as shown in window jamb 21 of FIGS. 1B, 8A, and 8B). In such an embodiment, a fastener may or may not be used. In various embodiments, the blind bracket 210 may be coupled to the clipping mechanism 205 without any fasteners (and/or tools to install), as discussed herein in reference to FIGS. 6A and 6B.

As shown in FIG. 3, an end view of the clipping mechanism 205 is provided. The clipping mechanism 205 may define a width (i.e., along the axis into the page). The width of the clipping mechanism 205 may be less than the length of the window jamb (e.g., a clipping mechanism 205 may be positioned near an edge of the top of a window). In various embodiments, multiple clipping mechanisms may be provided along the window jamb (e.g., a clipping mechanism 205 may be positioned at or near each end of the window jamb (e.g., based on the width of the blind)).

The clipping mechanism 205 includes a first receiving channel 300 and a second receiving channel 305. The clipping mechanism 205 may define a bracket side 350 and a jamb side 355. The first receiving channel 300 and the second receiving channel 305 may be defined on the bracket side 350 (e.g., in the direction of the blind bracket 210 upon mounting).

The first receiving channel 300 may be defined by a first channel protrusion 310 that extends from the bracket side 350 of the clipping mechanism 205. The first receiving channel 300 may be angled. As discussed in reference to FIG. 4, the first protrusion 400 of the blind bracket 210 may be defined at an angle 415. As such, the first receiving channel may also define an angle between the bracket side 350 and the first channel protrusion 310 that is the same or similar as angle 415. As such, the first receiving channel 300 is structured to receive the first protrusion 400.

In various embodiments, the first receiving channel 300 may be structured to receive a protrusion (e.g., the first protrusion 400 of the blind bracket 210). The first receiving channel 300 may include one or more channel protrusions 315. The channel protrusion 315 may engage the first protrusion 400 of the blind bracket 210 to couple the clipping mechanism 205 and the blind bracket 210. As such, the first protrusion 400 of the blind bracket 210 may be structured with a tooth structure 410 to engage within the first receiving channel 300.

The second receiving channel 305 may be defined by one or more second channel protrusions 320A, 320B. The second receiving channel 305 may be generally perpendicular from the bracket side 350 of the clipping mechanism 205. As such, the one or more second channel protrusions 320A, 320B may extend laterally from the bracket side 350 of the clipping mechanism 205. In such an instance, the second receiving channel 305 may be defined between the second channel protrusions 320A, 320B.

In various embodiments, the second receiving channel 305 may be structured to receive a protrusion (e.g., the second protrusion 405 of the blind bracket 210). The second receiving channel 305 may include one or more channel protrusions 325A, 325B. The channel protrusion(s) 325A, 325B may engage the second protrusion 405 of the blind bracket 210 to couple the clipping mechanism 205 and the blind bracket 210. As such, the first protrusion 400 of the blind bracket 210 may be structured with a tooth structure 425 to engage within the first receiving channel 300.

In various embodiments, a jamb side protrusion 360 may extend from the jamb side 355 of the clipping mechanism 205. The jamb side protrusion 360 extends laterally from the jamb side 355 of the clipping mechanism (e.g., generally perpendicular from the jamb side 355). The jamb side protrusion 360 may engage with the window jamb upon attachment of the clipping mechanism 205 to the window jamb. In various embodiments, as shown, the jamb side protrusion 360 may contact with the window jamb.

In various embodiments, the clipping mechanism 205 may include one or more fastener aperture 365 provided to allow a fastener to pass therethrough (e.g., to attach the clipping mechanism 205 to the window jamb 20). In various embodiments, the fastener aperture 365 may align with a screw boss or other fastener securing mechanism defined within the window jamb (e.g., such as the receptor channel 38).

Referring now to FIG. 4, an end view of the blind bracket 210 is shown. The blind bracket 210 may define a width (i.e., along the axis into the page). The width of the blind bracket 210 may be less than the length of the window jamb (e.g., a blind bracket 210 may be positioned near an edge of the top of a window). In various embodiments, multiple clipping mechanisms may be provided along the window jamb (e.g., a blind bracket 210 may be positioned at or near each end of the window jamb (e.g., based on the width of the blind)). The blind bracket 210 may have the same or similar width as the clipping mechanism. Alternatively, the blind bracket 210 may have a greater width than the clipping mechanism 205.

In various embodiments, the blind bracket 210 includes an attachment side 450 and an extending side 455. In various embodiments, the attachment side 450 and the extending side 455 may be formed out of a single piece of material. For example, the attachment side 450 and the extending side 455 may be defined via a bend (e.g., the attachment side 450 is generally perpendicular to the extending side 455). Alternatively, the attachment side 450 and the extending side 455 may be made out of multiple pieces of material (e.g., joined via welding, glue, fasteners, etc.). Regardless, the attachment side 450 and the extending side 455 may be generally perpendicular to one another and meet at a meeting point 470.

The attachment side 450 may include a first protrusion 400 and a second protrusion 405. As discussed in more detail in reference to FIGS. 6A and 6B, the first protrusion 400 is structured to engage with the first receiving channel 300 of the clipping mechanism 205 and the second protrusion is structured to engage with the second receiving channel 305 of the clipping mechanism 205. In various embodiments, the engagement of the first protrusion 400 with the first receiving channel 300 of the clipping mechanism 205 and the second protrusion 405 with the second receiving channel 305 of the clipping mechanism 205 provides for the coupling of the blind bracket 210 to the clipping mechanism 205.

In various embodiments, the first protrusion 400 may extend at an angle 415 from the attachment side 450 of the blind bracket 210. As shown, the protrusion 400 may define an angle 415 between the first protrusion 400 and the attachment side 450. The angle 415 may be an acute angle (i.e., less than 90 degrees). As such, the first protrusion 400 may be angled in the direction of the top of the page, as shown in FIG. 4). In various embodiments, the angle 415 may be between approximately 15 degrees and approximately 90 degrees. In various embodiments, the angle 415 may be between approximately 15 degrees and approximately 75 degrees. In various embodiments, the angle 415 may be between approximately 15 degrees and approximately 60 degrees. In various embodiments, the angle 415 may be between approximately 15 degrees and approximately 45 degrees. In various embodiments, the angle 415 may be between approximately 45 degrees.

The first protrusion 400 may be structured to fit within the first receiving channel 300. In various embodiments, a portion of the first receiving channel 300 may parallel to the angle of the first protrusion 400. As such, the first protrusion 400 may engage the portion of the first receiving channel 300 that is parallel upon engagement of the blind bracket 210 and the clipping mechanism 205. The first protrusion 400 may include a tooth structure 410 to engage with the channel protrusion 315 of the first receiving channel 300. The tooth structure 410 may be defined at an end of the first protrusion 400 opposite the attachment side 450. The tooth structure 410, as shown in FIG. 4 may be thicker than the rest of the first protrusion 400. In various embodiments, the tooth structure 410 may be a circular shape. In various embodiments, the tooth structure 410 may be any other shape, such as triangular, square, rectangular, or the like.

In various embodiments, the second protrusion 405 may be defined at a position along the attachment side 450 farther from the meeting point 470 (e.g., farther from the extending side 455). In various embodiments, the second protrusion may extend laterally (e.g., generally perpendicular) from the attachment side 450.

The second protrusion 405 may be structured to fit within the second receiving channel 305. The second protrusion 405 may include a tooth structure 425 to engage with the channel protrusion(s) 325A, 325B of the second receiving channel 305. The tooth structure 425 may be defined at an end of the second protrusion 405 opposite the attachment side 450. The tooth structure 425, as shown in FIG. 4 may be thicker than the rest of the second protrusion 405. In various embodiments, the tooth structure 425 may be a triangular shape. In various embodiments, the tooth structure 425 may be any other shape, such as circular, square, rectangular, or the like.

In various embodiments, the engagement of the first protrusion 400 and/or the second protrusion 405 with the clipping mechanism 205 may provide a holding force to maintain the coupling of the blind bracket 210 and the clipping mechanism 205. For example, the engagement of the first protrusion 400 and/or the second protrusion 405 with the clipping mechanism 205 may restrict the rotational force of the blind bracket 210 (e.g., thereby securing the blind bracket 210 and blind 215 relative to the clipping mechanism 205 and the window jamb).

In various embodiments, the attachment side 450 of the blind bracket 210 may be shaped with one or more bends, such that while the attachment side 450 is generally along a first axis, the attachment side 450 may not necessarily be straight. The attachment side 450 may be shaped with an extension from which the first protrusion 400 extends. As such, the first protrusion 400 may be shorter than the second protrusion 405. However, this is merely an example, in various embodiments, the attachment side 450 may be generally straight.

In various embodiments, the first protrusion 400 and the second protrusion 405 may have a similar or the same length. In various embodiments, the extending side 455 may also have one or more extensions in which the extending side is not straight. However, as shown in FIG. 4, the extending side 455 extends in a generally perpendicular manner relative to the attachment side 450.

The extending side 455 extends laterally from the attachment side 450 and extends upon placement laterally from the structure (e.g., the window jamb). The attachment side 450 and/or the extending side 455 may include a blind coupling mechanism (e.g., tab 460 and/or tab 465) that engages with a blind to couple the blind to the blind bracket 210 (e.g., snap-fit the blind into the blind bracket 210). The tab 600 of the blind 215 may engage with the tab 460 of the blind bracket 210 and the tab 605 of the blind 215 may engage with the tab 465 of the blind bracket 210. As such, a blind 215 may be placed within the blind bracket 210, such that tab 460 and/or tab 465 may engage with the blind to fix the top rail of the blind to the window jamb, as shown in FIGS. 2A and 2B. Additionally or alternatively, a blind bracket 210 (along other components of the window jamb assembly 200) may be defined along a bottom edge of the window frame to receive a bottom rail of the blind.

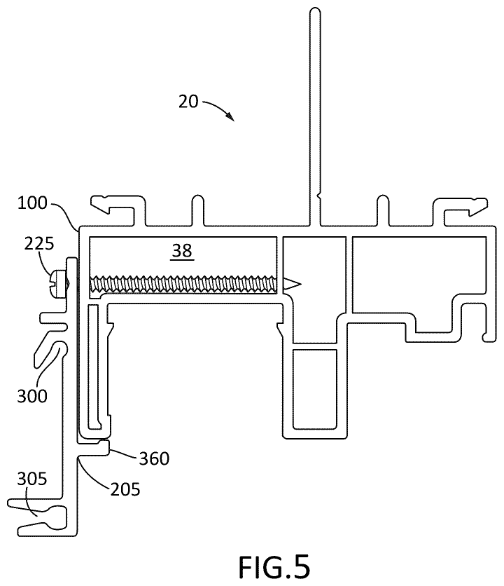

Referring now to FIG. 5, the clipping mechanism 205 is shown attached to the window jamb 20. As shown, the clipping mechanism 205 may be attached to the window jamb 20 via a fastener 225. The fastener 225 may be positioned through the fastener aperture 365 (shown in FIG. 3) and into the window jamb (e.g., into a screw boss or other fastener securing mechanism defined within the receptor channel 38). As shown, the clipping mechanism 205 may be secured to the window jamb 20 before the blind bracket 210 is coupled to the clipping mechanism 205 (as shown in FIGS. 6A and 6B). While the clipping mechanism 205 is shown being coupled to the window jamb 20 before the blind bracket 210 is coupled to the clipping mechanism 205, various embodiments may allow the blind bracket 210 to be coupled to the clipping mechanism 205 before the clipping mechanism 205 is coupled to the window jamb.

Referring now to FIGS. 6A and 6B, an example method of coupling the blind bracket 210 to the clipping mechanism 205 (FIG. 6A) and an example method of coupling the blind 215 to the blind bracket 210 (FIG. 6B) are shown. As shown in FIG. 5, the clipping mechanism 205 may be attached to the first end 100 of a window jamb (e.g., window jamb 20). The clipping mechanism 205 may be attached via a fastener 225. As discussed in reference to FIGS. 8A-11, the clipping mechanism 205 may also have one or more clipping mechanism protrusions 900 that frictionally fit with the window jamb. Additionally, while the coupling of the blind bracket 210 to the clipping mechanism 205 is shown after the clipping mechanism 205 is attached to the window jamb, in various embodiments, the clipping mechanism 205 may be attached to the window jamb after the blind bracket 210 has been coupled to the clipping mechanism 205.

As shown in FIG. 6A, the blind bracket 210 may be tilted to insert the first protrusion 400 into the first receiving channel 300, while the second protrusion 405 is not inserted (or at least not fully inserted) into the second receiving channel 305. Upon insertion of the first protrusion 400 into the first receiving channel 300, the blind bracket 210 may be rotated in the direction of the clipping mechanism 205 (e.g., rotated counterclockwise based on the orientation of FIGS. 6A and 6B). Upon rotation, the second protrusion 405 is inserted into the second receiving channel 305. The engagement of the first protrusion 400 and the second protrusion 405 secure the blind bracket 210 to the clipping mechanism 205.

As shown in FIG. 6B, the blind 215 may also be snap-fit into the blind bracket 210. The blind 215 may be coupled to the blind bracket 210 after the blind bracket 210 is coupled to the clipping mechanism 205 (e.g., as shown in FIGS. 6A and 6B). Alternatively, the blind 215 may be coupled to the blind bracket 210 before the blind bracket 210 is coupled to the clipping mechanism 205. In various embodiments, the blind 215 may be secured within the blind bracket 210 without any permanent fasteners.

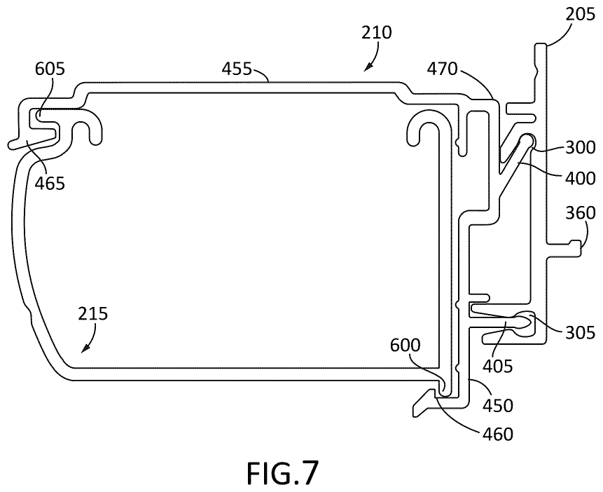

Referring now to FIG. 7, an end view of the window jamb assembly 200 without a window jamb is provided. As stated above, the blind bracket 210 is coupled to the clipping mechanism via the engagement of the first protrusion 400 with the first receiving channel 300 and the second protrusion 405 with the second receiving channel 305. The blind 215 may be mounted within the blind bracket 210 by engagement of the tabs 460, 465 of the blind bracket 210 with the tabs 600, 605 of the blind 215. The blind 215 may be structured to snap-fit into a coupling with the blind bracket 210.

Referring now to FIGS. 8A-11, a window jamb assembly 800 is provided used with window jamb 21 shown in FIG. 1B. As discussed herein, the window jamb assembly components (e.g., the clipping mechanism 205, the blind bracket 210, and/or the blind 215) may be used with various different style of window jambs. Additionally, the components of the window jamb assembly 800 may be interchanged with the components of the window jamb assembly 200. In various embodiments, a component of the window jamb assembly 800 may be the same as the corresponding component of the window jamb assembly 200. For example, the blind bracket 210 shown in FIG. 8A is the same as the blind bracket 210 shown in FIG. 2A. Additionally or alternatively, the components may be altered to improve the usage of the components. For example, the clipping mechanism 205 of FIGS. 8A and 8B is different from the clipping mechanism 205 of FIG. 2A. In various embodiments, the clipping mechanism 205 may be altered based on the type of window jamb and the blind bracket 210 may be the same across different window jambs.

FIGS. 8A and 8B illustrate different ways in which a window jamb (and subsequently the window jamb assembly 800) may be mounted. FIG. 8A illustrates a window jamb 21 with a drywall return (e.g., the window jamb 21 is adjacent to wall 220). FIG. 8B illustrates using an extender 801 to connect the window jamb 21 to the surface 805 (e.g., a wall). The extender 801 may be used in various different configurations. As shown, the clipping mechanism 205 and/or the blind bracket 210 may be used with various different window jamb designs, as well as various different window jamb installations.

FIG. 8A illustrates a drywall return configuration in which the blind bracket 210 defines a space between the blind bracket and the wall 220. FIG. 8B is designed for the blind bracket 210 to be positioned adjacent to the surface 805 (e.g., a wall). For example, the extending side 455 may be adjacent or in contact with the surface 805. In various embodiments, an attachment fastener 815 may be attach the blind bracket 210 to the surface 805. For example, as shown, the extending side 455 may define an aperture to receive the attachment fastener 815 (e.g., a screw or other fastener). In various embodiments, the attachment fastener 815 may be optional (e.g., the blind bracket 210 may be secured via the connection between the clipping mechanism 205 and the blind bracket 210). In an instance in which an attachment fastener 815 is used in an embodiment, the attachment fastener 815 may provide additional securing of the window jamb assembly 800.

FIG. 8B illustrates using an extender 801 to connect the window jamb 21 to the surface 805 (e.g., a wall). As shown, the surface 805 may be prepared with an indention 810 to receive a portion of the clipping mechanism 205. For example, the indention 810 may be cut out of the end of the surface 805. In such an embodiment, the blind bracket 210 may be positioned directly adjacent to the surface 805 (e.g., in contact with the surface 805). The window jamb assembly may be used in various different configurations, as shown herein.

Referring now to FIG. 9, the clipping mechanism 205 is shown coupled to the window jamb 21. As shown, the clipping mechanism 205 may be coupled to the window jamb 21 via a fastener 225 and/or a clipping mechanism protrusion 900. Similar to the clipping mechanism discussed in reference to the window jamb assembly 200, the clipping mechanism 205 may include one or more fastener apertures 365A, 365B. The fastener apertures may be defined relative to a screw boss or other fastener receiving mechanism of the window jamb, such that the fastener aperture(s) align with the screw boss or other fastener receiving mechanism upon placement of the clipping mechanism 205 for coupling with the window jamb. As shown, the fastener aperture(s) may be defined above the first receiving channel 300.

The clipping mechanism protrusion 900 may also be defined to couple the clipping mechanism 205 to the window jamb. The clipping mechanism protrusion 900 may extend laterally from the jamb side protrusion 360. In various embodiments, the window jamb (e.g., window jamb 21) may define a clipping mechanism channel 50 that receives the clipping mechanism protrusion 900. The clipping mechanism protrusion 900 may include one or more teeth protrusions 905 to frictionally engage with the clipping mechanism channel 50. The clipping mechanism channel 50 may also define one or more teeth protrusions 55 (e.g., to provide a frictional holding force for the clipping mechanism protrusion 900).

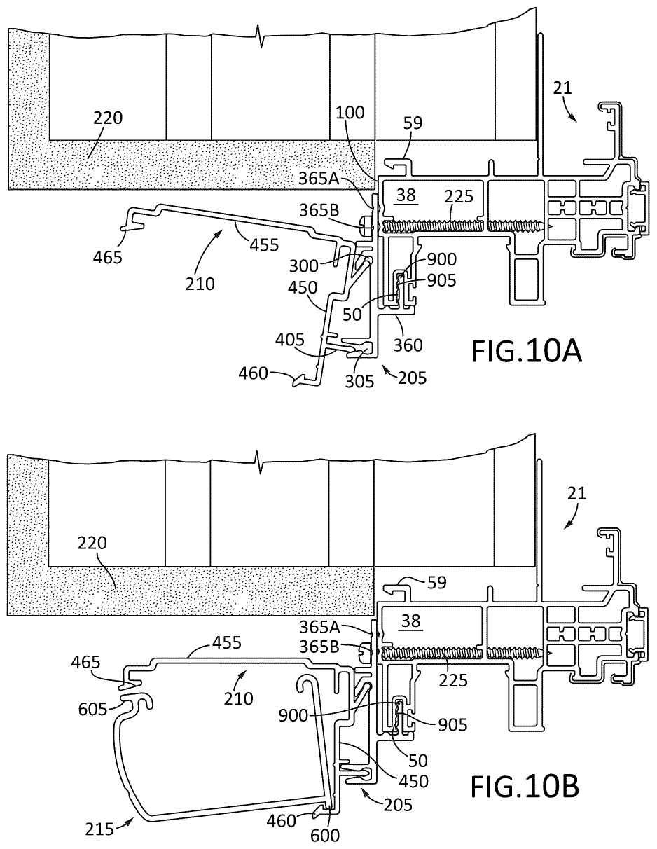

Referring now to FIGS. 10A and 10B, the coupling of the blind bracket 210 to the clipping mechanism 205 is shown for the drywall return configuration shown in FIG. 8A. The coupling of the blind bracket 210 to the clipping mechanism 205 in FIG. 10A and the coupling of the blind 215 to the blind bracket 210 in FIG. 10B is completed in the same fashion as the methods discussed in reference to FIGS. 6A and 6B. The clipping mechanism 205 may be attached via a fastener 225. Additionally, while the coupling of the blind bracket 210 to the clipping mechanism 205 is shown after the clipping mechanism 205 is attached to the window jamb, in various embodiments, the clipping mechanism 205 may be attached to the window jamb after the blind bracket 210 has been coupled to the clipping mechanism 205.

As previously discussed in reference to FIG. 6A, the blind bracket 210 may be tilted to insert the first protrusion 400 into the first receiving channel 300, while the second protrusion 405 is not inserted (or at least not fully inserted) into the second receiving channel 305. Upon insertion of the first protrusion 400 into the first receiving channel 300, the blind bracket 210 may be rotated in the direction of the clipping mechanism 205 (e.g., rotated counterclockwise based on the orientation of FIGS. 6A and 6B). Upon rotation, the second protrusion 405 is inserted into the second receiving channel 305. The engagement of the first protrusion 400 and the second protrusion 405 secure the blind bracket 210 to the clipping mechanism 205.

FIG. 10B illustrates the blind 215 being inserted into the blind bracket 210 (e.g., the blind 215 is snap-fit into the blind bracket 210). As shown, the tab 600 engages with the tab 460. The blind is then rotated in the direction of the extending side 455 of the blind bracket (e.g., in a clockwise rotation) and the tab 605 engages with the tab 465 to provide a snap fit between the blind bracket 210 and the blind 215.

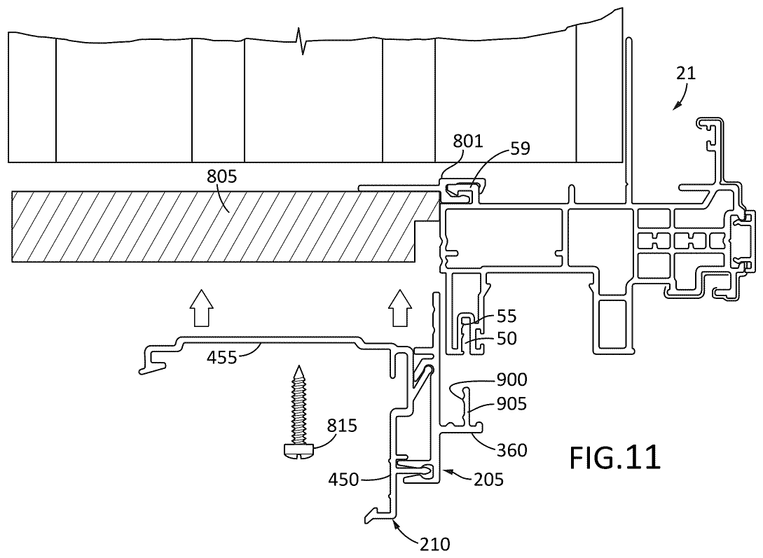

Referring now to FIG. 11, another installation of the window jamb assembly 800 is shown for the extender configuration shown in FIG. 8B. As shown, the clipping mechanism 205 and the blind bracket 210 may be coupled before coupling the clipping mechanism 205 to the window jamb. The clipping mechanism 205 may also be attached to the window jamb 21 via connection between the clipping mechanism protrusion 900 and the clipping mechanism channel 50. The fastener apertures 365A, 365B may not be accessible in certain configurations, as shown in FIG. 11, and the connection between the clipping mechanism protrusion 900 and the clipping mechanism channel 50 may be the only holding force between the window jamb and the clipping mechanism 205. In various embodiments, an attachment fastener 815 may be used to further secure the window jamb assembly 800. The attachment fastener 815 attaches the blind bracket 210 to the surface 805 (e.g., a wall). In various embodiments, the attachment fastener 815 may also be used in other configurations (e.g., a user may use the attachment fastener 815 to provide additional support for the window jamb assembly).

Unless stated otherwise, any of the configurations of various embodiments may be used interchangeably. It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

### IV. Claim Clauses

Clause 1. A window jamb assembly, comprising: a clipping mechanism attachable to a window jamb, wherein the clipping mechanism comprises a first receiving channel and a second receiving channel; and a blind bracket removably coupled to the clipping mechanism, wherein the blind bracket comprises a first protrusion extending from an attachment side of the blind bracket and a second protrusion extending laterally from the attachment side of the blind bracket, wherein the first protrusion engages the first receiving channel and the second protrusion engages the second receiving channel, and wherein the first protrusion and the second protrusion provide a holding force to maintain the coupling of the blind bracket to the clipping mechanism.

Clause 2. The window jamb assembly of Clause 1, wherein the clipping mechanism is attachable to the window jamb via at least one fastener, wherein the window jamb comprises a screw boss to receive the at least one fastener.

Clause 3. The window jamb assembly of Clause 1, wherein a portion of the first receiving channel is parallel to the first protrusion, wherein the first protrusion engages the portion of the first receiving channel is parallel upon engagement of the blind bracket and the clipping mechanism.

Clause 4. The window jamb assembly of Clause 1, wherein the first protrusion defines an angle less than 90 degrees relative to the attachment side of the blind bracket.

Clause 5. The window jamb assembly of Clause 4, wherein the first protrusion restricts a rotational force of the blind bracket.

Clause 6. The window jamb assembly of Clause 1, wherein the first receiving channel is defined between a first channel protrusion and a bracket side of the clipping mechanism.

Clause 7. The window jamb assembly of Clause 1, wherein the first protrusion engages the first receiving channel via engagement of a tooth structure with a channel protrusion within the first receiving channel.

Clause 8. The window jamb assembly of Clause 1, wherein the blind bracket comprises a first tab on an extending side of the blind bracket and a second tab on the attachment side of the blind bracket, wherein a blind is attachable to the blind bracket via an engagement with the first tab and the second tab.

Clause 9. The window jamb assembly of Clause 1, wherein the attachment side of the blind bracket is perpendicular to an extending side of the blind bracket.

Clause 10. The window jamb assembly of Clause 1, wherein the first protrusion is shorter than the second protrusion.

Clause 11. A method of installing a window jamb assembly, the method comprising: attaching a clipping mechanism attachable to a window jamb, wherein the clipping mechanism comprises a first receiving channel and a second receiving channel; and coupling a blind bracket to the clipping mechanism, wherein the blind bracket comprises a first protrusion extending from an attachment side of the blind bracket and a second protrusion extending laterally from the attachment side of the blind bracket, wherein coupling the blind bracket to the clipping mechanism comprises engaging the first protrusion with the first receiving channel and engaging the second protrusion with the second receiving channel, and wherein the first protrusion and the second protrusion provide a holding force to maintain the coupling of the blind bracket to the clipping mechanism.

Clause 12. The method of Clause 11, wherein the clipping mechanism is attached to the window jamb via at least one fastener, wherein the window jamb comprises a screw boss to receive the at least one fastener.

Clause 13. The method of Clause 11, wherein a portion of the first receiving channel is parallel to the first protrusion, wherein the first protrusion engages the portion of the first receiving channel is parallel upon engagement of the blind bracket and the clipping mechanism.

Clause 14. The method of Clause 11, wherein the first protrusion defines an angle less than 90 degrees relative to the attachment side of the blind bracket.

Clause 15. The method of Clause 14, wherein the first protrusion restricts a rotational force of the blind bracket.

Clause 16. The method of Clause 11, wherein the first receiving channel is defined between a first channel protrusion and a bracket side of the clipping mechanism.

Clause 17. The method of Clause 11, wherein the first protrusion engages the first receiving channel via engagement of a tooth structure with a channel protrusion within the first receiving channel.

Clause 18. The method of Clause 11, wherein the blind bracket comprises a first tab on an extending side of the blind bracket and a second tab on the attachment side of the blind bracket, wherein a blind is attachable to the blind bracket via an engagement with the first tab and the second tab.

Clause 19. The method of Clause 11, wherein the attachment side of the blind bracket is perpendicular to an extending side of the blind bracket.

Clause 20. The method of Clause 11, wherein the first protrusion is engaged with the first receiving channel before the second protrusion engages with the second receiving channel during the coupling of the blind bracket and the clipping mechanism.

Clause 21. A window jamb assembly, comprising: a clipping mechanism attachable to a window jamb, wherein the clipping mechanism comprises a first receiving channel and a second receiving channel, wherein the clipping mechanism is attachable to a window jamb via at least one friction fitting between the clipping mechanism and the window jamb; and a blind bracket removably coupled to the clipping mechanism, wherein the blind bracket comprises a first protrusion extending from an attachment side of the blind bracket and a second protrusion extending laterally from the attachment side of the blind bracket, wherein the first protrusion engages the first receiving channel and the second protrusion engages the second receiving channel, and wherein the first protrusion and the second protrusion provide a holding force to maintain the coupling of the blind bracket to the clipping mechanism.

Clause 22. The window jamb assembly of Clause 21, wherein the clipping mechanism is attachable to the window jamb via at least one fastener, wherein the window jamb comprises a screw boss to receive the at least one fastener.

Clause 23. The window jamb assembly of Clause 21, wherein a portion of the first receiving channel is parallel to the first protrusion, wherein the first protrusion engages the portion of the first receiving channel is parallel upon engagement of the blind bracket and the clipping mechanism.

Clause 24. The window jamb assembly of Clause 21, wherein the first protrusion defines an angle less than 90 degrees relative to the attachment side of the blind bracket.

Clause 25. The window jamb assembly of Clause 24, wherein the first protrusion restricts a rotational force of the blind bracket.

Clause 26. The window jamb assembly of Clause 21, wherein the first receiving channel is defined between a first channel protrusion and a bracket side of the clipping mechanism.

Clause 27. The window jamb assembly of Clause 21, wherein the first protrusion engages the first receiving channel via engagement of a tooth structure with a channel protrusion within the first receiving channel.

Clause 28. The window jamb assembly of Clause 21, wherein the blind bracket comprises a first tab on an extending side of the blind bracket and a second tab on the attachment side of the blind bracket, wherein a blind is attachable to the blind bracket via an engagement with the first tab and the second tab.

Clause 29. The window jamb assembly of Clause 21, wherein the attachment side of the blind bracket is perpendicular to an extending side of the blind bracket.

Clause 30. The window jamb assembly of Clause 21, wherein the first protrusion is shorter than the second protrusion.

Clause 31. The window jamb assembly of Clause 21, wherein the blind bracket defines a fastener aperture on an extending side of the blind bracket to fasten the blind bracket to a ceiling or a wall.

Clause 32. A method of installing a window jamb assembly, the method comprising: attaching a clipping mechanism attachable to a window jamb, wherein the clipping mechanism comprises a first receiving channel and a second receiving channel, wherein the clipping mechanism is attached to a window jamb via at least one friction fitting between the clipping mechanism and the window jamb; and coupling a blind bracket to the clipping mechanism, wherein the blind bracket comprises a first protrusion extending from an attachment side of the blind bracket and a second protrusion extending laterally from the attachment side of the blind bracket, wherein coupling the blind bracket to the clipping mechanism comprises engaging the first protrusion with the first receiving channel and engaging the second protrusion with the second receiving channel, and wherein the first protrusion and the second protrusion provide a holding force to maintain the coupling of the blind bracket to the clipping mechanism.

Clause 33. The method of Clause 32, wherein the clipping mechanism is attached to the window jamb via at least one fastener, wherein the window jamb comprises a screw boss to receive the at least one fastener.

Clause 34. The method of Clause 32, wherein a portion of the first receiving channel is parallel to the first protrusion, wherein the first protrusion engages the portion of the first receiving channel is parallel upon engagement of the blind bracket and the clipping mechanism.

Clause 35. The method of Clause 32, wherein the first protrusion defines an angle less than 90 degrees relative to the attachment side of the blind bracket.

Clause 36. The method of Clause 35, wherein the first protrusion restricts a rotational force of the blind bracket.

Clause 37. The method of Clause 32, wherein the first receiving channel is defined between a first channel protrusion and a bracket side of the clipping mechanism.

Clause 38. The method of Clause 32, wherein the first protrusion engages the first receiving channel via engagement of a tooth structure with a channel protrusion within the first receiving channel.

Clause 39. The method of Clause 32, wherein the blind bracket comprises a first tab on an extending side of the blind bracket and a second tab on the attachment side of the blind bracket, wherein a blind is attachable to the blind bracket via an engagement with the first tab and the second tab.

Clause 40. The method of Clause 32, wherein the attachment side of the blind bracket is perpendicular to an extending side of the blind bracket.

Clause 41. The method of Clause 32, wherein the first protrusion is engaged with the first receiving channel before the second protrusion engages with the second receiving channel during the coupling of the blind bracket and the clipping mechanism.

Clause 42. The window jamb assembly of Clause 21, further comprising securing the blind bracket to a wall via an attachment fastener, wherein the blind bracket defines a fastener aperture on an extending side of the blind bracket to fasten the blind bracket to the wall via the attachment fastener.

Therefore, the following is claimed:

1. A window jamb assembly, comprising:
a clipping mechanism attachable to a window jamb, wherein the clipping mechanism comprises a first receiving channel and a second receiving channel; and
a blind bracket removably coupled to the clipping mechanism,
wherein the blind bracket comprises a first protrusion extending from an attachment side of the blind bracket and a second protrusion extending laterally from the attachment side of the blind bracket,
wherein the first protrusion engages the first receiving channel and the second protrusion engages the second receiving channel, and
wherein the first protrusion and the second protrusion provide a holding force to maintain the coupling of the blind bracket to the clipping mechanism.

2. The window jamb assembly of claim 1, wherein the clipping mechanism is attachable to the window jamb via at least one fastener, wherein the window jamb comprises a screw boss to receive the at least one fastener.

3. The window jamb assembly of claim 1, wherein a portion of the first receiving channel is parallel to the first protrusion, wherein the first protrusion engages the portion of the first receiving channel is parallel upon engagement of the blind bracket and the clipping mechanism.

4. The window jamb assembly of claim 1, wherein the first protrusion defines an angle less than 90 degrees relative to the attachment side of the blind bracket.

5. The window jamb assembly of claim 4, wherein the first protrusion restricts a rotational force of the blind bracket.

6. The window jamb assembly of claim 1, wherein the first receiving channel is defined between a first channel protrusion and a bracket side of the clipping mechanism.

7. The window jamb assembly of claim 1, wherein the first protrusion engages the first receiving channel via engagement of a tooth structure with a channel protrusion within the first receiving channel.

8. The window jamb assembly of claim 1, wherein the blind bracket comprises a first tab on an extending side of the blind bracket and a second tab on the attachment side of the blind bracket, wherein a blind is attachable to the blind bracket via an engagement with the first tab and the second tab.

9. The window jamb assembly of claim 1, wherein the attachment side of the blind bracket is perpendicular to an extending side of the blind bracket.

10. The window jamb assembly of claim 1, wherein the first protrusion is shorter than the second protrusion.

11. A method of installing a window jamb assembly, the method comprising:
attaching a clipping mechanism attachable to a window jamb, wherein the clipping mechanism comprises a first receiving channel and a second receiving channel; and
coupling a blind bracket to the clipping mechanism, wherein the blind bracket comprises a first protrusion extending from an attachment side of the blind bracket and a second protrusion extending laterally from the attachment side of the blind bracket,
wherein coupling the blind bracket to the clipping mechanism comprises engaging the first protrusion with the first receiving channel and engaging the second protrusion with the second receiving channel, and
wherein the first protrusion and the second protrusion provide a holding force to maintain the coupling of the blind bracket to the clipping mechanism.

12. The method of claim 11, wherein the clipping mechanism is attached to the window jamb via at least one fastener, wherein the window jamb comprises a screw boss to receive the at least one fastener.

13. The method of claim 11, wherein a portion of the first receiving channel is parallel to the first protrusion, wherein the first protrusion engages the portion of the first receiving channel is parallel upon engagement of the blind bracket and the clipping mechanism.

14. The method of claim 11, wherein the first protrusion defines an angle less than 90 degrees relative to the attachment side of the blind bracket.

15. The method of claim 14, wherein the first protrusion restricts a rotational force of the blind bracket.

16. The method of claim 11, wherein the first receiving channel is defined between a first channel protrusion and a bracket side of the clipping mechanism.

17. The method of claim 11, wherein the first protrusion engages the first receiving channel via engagement of a tooth structure with a channel protrusion within the first receiving channel.

18. The method of claim 11, wherein the blind bracket comprises a first tab on an extending side of the blind bracket and a second tab on the attachment side of the blind bracket, wherein a blind is attachable to the blind bracket via an engagement with the first tab and the second tab.

19. The method of claim 11, wherein the attachment side of the blind bracket is perpendicular to an extending side of the blind bracket.

20. The method of claim 11, wherein the first protrusion is engaged with the first receiving channel before the second protrusion engages with the second receiving channel during the coupling of the blind bracket and the clipping mechanism.
